(19) United States
(12) Patent Application Publication
(10) Pub. No.: US 2019/0347636 A1
(43) Pub. Date: Nov. 14, 2019

(54) PRODUCT RECOGNITION APPARATUS, SALES DATA PROCESSING APPARATUS, AND CONTROL METHOD

(71) Applicant: TOSHIBA TEC KABUSHIKI KAISHA, Tokyo (JP)

(72) Inventor: Yuishi TAKENO, Numazu Shizuoka (JP)

(21) Appl. No.: 16/519,040

(22) Filed: Jul. 23, 2019

Related U.S. Application Data
(63) Continuation of application No. 14/995,564, filed on Jan. 14, 2016.

(30) Foreign Application Priority Data
Jan. 23, 2015 (JP) 2015-011444

(51) Int. Cl. G06Q 20/20; G06K 9/03; G07G 1/00

(52) U.S. Cl. CPC G06Q 20/208; G06T 11/60; G07G 1/0063; G06K 9/033

(57) ABSTRACT

According to the embodiment, a product recognition apparatus includes a shooting device, a display, and a processor. The aforementioned processor controls the display so that a frame image of an object shot by the shooting device is displayed in an image display region of the display. Also, the processor controls the display so that a location image illustrating the location of the object is displayed so as to overlap the frame image in the image display region of the display.

### CROSS-REFERENCE TO RELATED APPLICATIONS

This application is a continuation of U.S. patent application Ser. No. 14/995,564, filed on Jan. 14, 2016, which is based upon and claims the benefit of priority from the prior Japanese Patent Application No. 2015-011444, filed on Jan. 23, 2015, the entire contents of each of which are incorporated herein by reference.

### FIELD

The embodiments herein illustrated relate generally to a product recognition apparatus, a sales data processing apparatus, and a control method.

### BACKGROUND

A product recognition apparatus that recognizes a product from an image of the product shot using, e.g., a video camera, is embedded in, e.g., a POS (point-of-sale) device for embodiment of the product recognition apparatus.

The technique to input various types of operations based on a change of the location of a product in an image in the aforementioned product recognition apparatus is already known. An operator can use this technique to perform various types of operations by moving a product held in the hand of the operator so that the product is recognized by the product recognition apparatus.

However, a change of the location of a product detected by a product recognition apparatus eventually differs from a product movement sensed by an operator. In such an event, there is a possibility that an operation input in response to the aforementioned movement the operator is delayed and that an operation not intended by the operator is erroneously input into the product recognition apparatus.

There is a call for enabling proper movement of a product by an operator so that an operation intended by the operator is appropriately input into the aforementioned product recognition apparatus.

### BRIEF DESCRIPTION OF DRAWINGS

FIG. 1 is an exterior view of a shop cashier system including a product read device according to an embodiment.

FIG. 2 is a block diagram of electronic elements of the shop cashier system according to the embodiment.

FIG. 3 is a diagram illustrating one example of defining functional regions based on setting information contained in a region setting table according to the embodiment.

FIG. 4 is a flowchart illustrating processing performed by a CPU of the product read device according to the embodiment.

FIG. 5 is a flowchart illustrating processing performed by the CPU of the product read device according to the embodiment.

FIG. 6 is a diagram illustrating one example of an operation screen according to the embodiment.

FIG. 7 is a diagram illustrating one example operation screen that has been updated from the operation screen illustrated in FIG. 6.

FIG. 8 is a diagram illustrating one example operation screen that has been updated from the operation screen illustrated in FIG. 7.

FIG. 9 is a diagram illustrating one example operation screen that has been updated from the operation screen illustrated in FIG. 8.

FIG. 10 is a diagram illustrating another example operation screen of the operation screen illustrated in FIG. 9.

### DETAILED DESCRIPTION

According to one embodiment, a product recognition apparatus includes a shooting device, a display, a memory, and a processor.

The shooting device shoots a moving image of a moving object and outputs frame data representing a frame image constituting this moving image.

The display displays a predetermined operation screen and the aforementioned frame image in an image display region defined in the operation screen.

The memory stores operation screen data for displaying the aforementioned operation screen and the frame data.

Based on the frame data stored in the memory, the processor recognizes an object contained in the frame image.

The processor detects the location of this recognized object in the frame image.

Based on the operation screen data and the frame data stored in the memory, the processor controls the display so that a location image illustrating the location of the object is displayed so as to overlap the frame image.

In addition, the processor accepts an input of the predetermined operation in response to detection of the location of the aforementioned object in an operational region that has been defined in the frame image in advance and associated with a predetermined operation.

Embodiments are hereinafter illustrated in reference to the drawings. In the drawings, an identical reference numeral denotes identical or similar elements. The embodiments are applications where a product sold at a shop, such as a supermarket, is a recognition target of a product read device. More specifically, the embodiments are applications where a vertical standing product read device is provided at a cashier counter of the aforementioned shop.

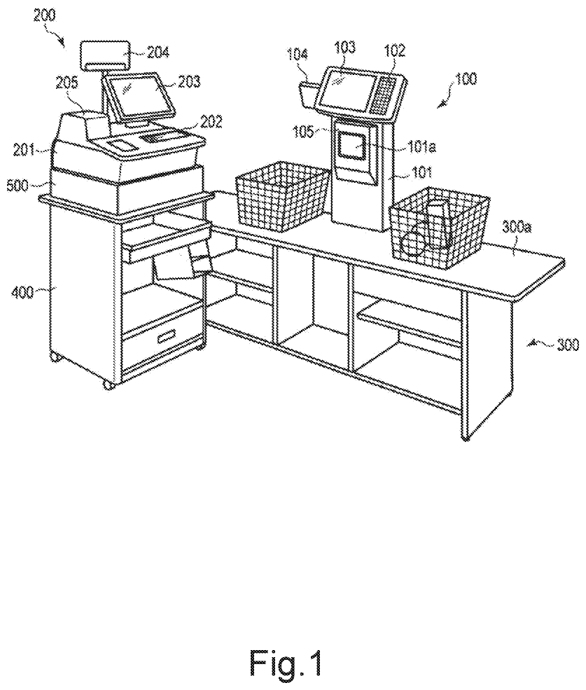

FIG. 1 is an exterior view of a shop cashier system including the product read device according to the embodiment. This shop cashier system is one example of a sales data processing apparatus.

The shop cashier system illustrated in FIG. 1 includes product read device 100 and a POS terminal 200.

The product read device 100 is provided on a cashier counter 300.

The POS terminal 200 is provided on a drawer 500 placed on a register stand 400.

The product read device 100 and the POS terminal 200 are electrically connected by an unillustrated communication cable.

An automatic change machine is eventually disposed instead of the drawer 500.

The product read device 100 includes a housing 101, a keyboard 102, an operator display 103, a customer display 104, and a shooting device 105.

The housing 101 is in a flat box form and stands on the cashier counter 300.

The keyboard 102, the operator display 103, and the customer display 104 are on the upper end of the housing 101. The shooting device 105 is in the interior of the housing 101.

The housing 101 includes a read window 101a that is opposite to the shooting device 105. The housing 101 enables the shooting device 105 to shoot, via the read window 101a, an object in front of the read window 101a.

The POS terminal 200 includes a housing 201, a keyboard 202, an operator display 203, a customer display 204, and a printer 205.

The keyboard 202 is placed on the housing 201 so that a part of the keyboard 202 is exposed to the outside. The operator display 203 and the customer display 204 are placed on the exterior of the housing 201, and the printer 205 is on the interior of the housing 201.

The cashier counter 300 includes a thin and long top plate 300a.

A customer passage (on the rear side in FIG. 1), which runs in the longitudinal direction of the top plate, and an operator space (on the front side in FIG. 1) are divided by the cashier counter 300.

The housing 101 is located at a substantially center of the top plate 300a in the longitudinal direction thereof. All of the keyboard 102, the operator display 103, and the read window 101a are directed toward the operator space side. The customer display 104 is directed toward the customer passage side.

The region on the upper surface of the top plate 300a upstream from the product read device 100 in the customer travel direction is used as a space to place a product that a customer wishes to purchase and has not been registered for sale.

The downstream region is a space to place a product that has been registered for sale.

In this way, a sold product is moved from the upstream region through the area in front of the read window 101a to the downstream region in the customer travel direction.

The dynamic direction of the sold product movement for sales registration largely coincides with the customer movement direction.

The standard dynamic line of a sold product (hereinafter referred to as the “standard dynamic line”) is from the right side to the left side in the horizontal line direction illustrated in FIG. 1.

A register stand 400 is placed on the operator space side so as to be next to the downstream end portion of the cashier counter 300 in the customer travel direction of the customer passage.

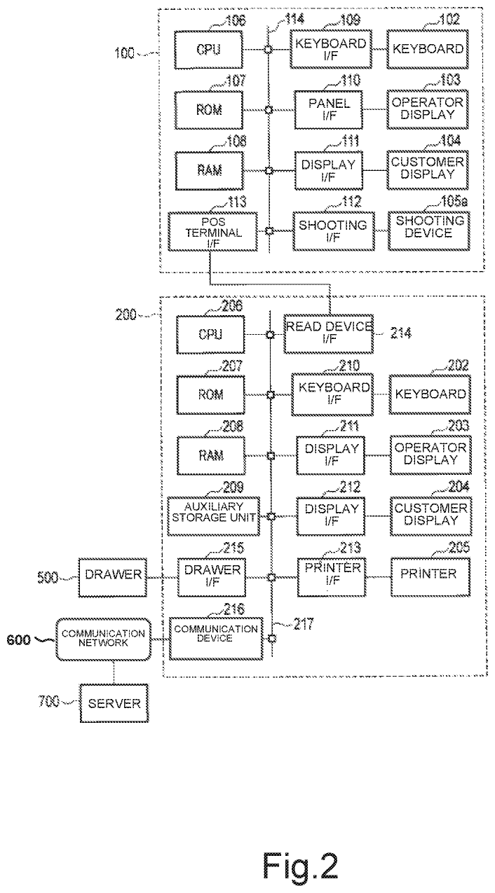

FIG. 2 is a block diagram of electronic elements of the shop cashier system illustrated in FIG. 1.

An element of FIG. 2 that is identical to the corresponding element of FIG. 1 is assigned the same reference numeral as the reference numeral of the corresponding element of FIG. 1.

In addition to the keyboard 102, the operator display 103, and the customer display 104, electronic elements of the product read device 100 include a shooting device 105a, a processor 106, a ROM (read-only memory) 107, a RAM (random-access memory) 108, a keyboard interface (keyboard I/F) 109, a panel interface (panel I/F) 110, a display interface (display I/F) 111, a shooting interface (shooting I/F) 112, a POS terminal interface (POS terminal I/F) 113, and a bus line 114.

The bus line 114 includes an address bus and a data bus and mutually connect the CPU 106, the ROM 107, the RAM 108, the keyboard interface 109, the panel interface 110, the display interface 111, the shooting interface 112, and the POS terminal interface 113.

The keyboard 102 includes a plurality of key switches and outputs a command that represents the content of an operation by an operator using these key switches.

The operator display 103 displays the below-mentioned predetermined operation screen and displays, in an image display region contained in this operation screen, a frame image shot by the shooting device 105.

Specifically, the operator display 103 is a touch panel including a display device, such as an LCD (liquid crystal display), and a transparent two-dimensional touch sensor disposed so as to overlap the display screen of this display device. Hereinafter, the operator display 103 is simply referred to as the touch panel 103.

Under control of the processor 106, the touch panel 103 displays an arbitrary image on the display device.

The touch panel 103 detects, using a two-dimensional touch sensor, the location of the portion of the display screen of the display device touched by an operator and displays coordinate data indicating the touch location.

The touch panel 103 is used to display an image illustrating various types of information to be presented to the operator and to input an operation by the operator.

Under control of the processor 106, the customer display 104 displays an arbitrary string or image.

The customer display 104 is used to display various types of strings and images to be presented to a customer. As the customer display 104, a fluorescent display device, an LCD, or the like can be used.

The shooting device 105 has a shooting region in a predetermined range and shoots a moving image of an object moving in the shooting region.

The shooting device 105 periodically outputs data representing a frame image.

Data representing a frame image is hereinafter referred to as frame data.

The frame image is an image of a frame constituting the aforementioned shot image.

Specifically, the shooting device 105 includes, e.g., a shooting device 105a and an unillustrated shooting lens.

The shooting device 105a includes a CCD (charge coupled device) shooting element, which is an area image sensor, and a drive circuit thereof. The shooting lens forms an image on the CCD shooting element.

The shooting region herein refers to, e.g., a region where an image is formed in the area of the CCD shooting element, wherein the image comes from the read window 101a via the shooting lens. The frame image is an image of this shooting region.

The shooting device 105a acquires frame data representing the frame image at a constant time interval and output the frame data.

The shooting direction of the shooting device 105a is from the inside of the housing 101 to the outside of the housing 101 through the read window 101a.

The direction of the standard product dynamic line is from the left to the right with reference to the shooting device 105a. The left side of the frame image is the upstream side of the standard dynamic line, and the right side of the frame image is the downstream side of the standard dynamic line.

The processor 106 is, e.g., a CPU (central processing unit). The processor 106 is hereinafter simply referred to as the CPU 106.

Based on an operating system, middleware, and application program stored in the ROM 107 and the RAM 108, the CPU 106 controls all elements of the product read device 100 to perform various types of operations of the product read device 100.

The ROM 107 stores the aforementioned operating system.

The ROM 107 eventually stores the aforementioned middleware and application program. Also, the ROM 107 eventually stores data to be referenced by the CPU 106 to execute various types of processing. The ROM 107 stores a region setting table.

The region setting table contains setting information that defines various types of functional regions in a frame image range (hereinafter referred to as the frame range). The functional region is, e.g., an operational region associated with a predetermined operation so as to achieve a function of the predetermined operation.

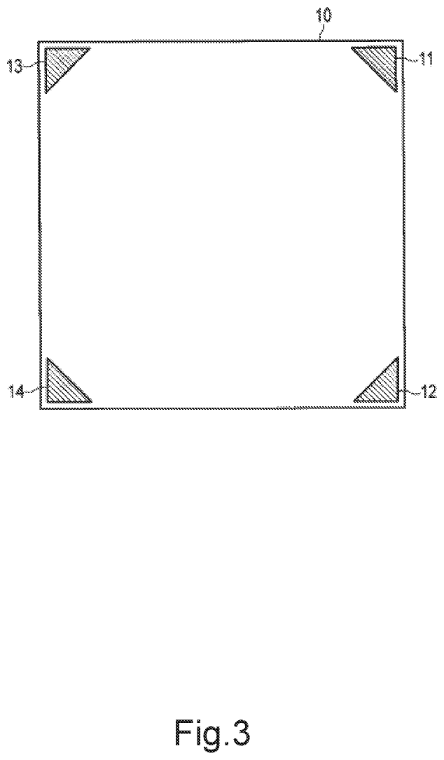

FIG. 3 is a diagram illustrating one example of defining functional regions based on setting information contained in a region setting table.

Four operational regions are defined in a frame range 10 of the example of FIG. 3. The four operational regions are a first candidate region 11, a second candidate region 12, a third candidate region 13, and a fourth candidate region 14.

The first candidate region 11 is a triangular region located at the upper corner on the downstream side of the standard dynamic line in the frame range 10.

The second candidate region 12 is a triangular region located at the lower corner on the downstream side of the standard dynamic line in the frame range 10.

The third candidate region 13 is a triangular region located at the upper corner on the upstream side of the standard dynamic line in the frame range 10.

The fourth candidate region 14 a triangular region located at the lower corner on the upstream side of the standard dynamic line in the frame range 10.

Each of the first candidate region 11 to the fourth candidate region 14 is associated with an operation for selecting one of the first to fourth candidates set based on the below-mentioned recognition processing.

A first candidate is a candidate product that is determined the most likely to be the object.

Second to fourth candidates are candidate products that are determined the second to fourth most likely to be the object.

It is possible to optionally change the type of selection operation for a candidate product to be associated with the first candidate region 11, the second candidate region 12, the third candidate region 13, and the fourth candidate region 14. Also, the arrangement and shape of each region are also optional.

The RAM 108 stores data to be referenced by the CPU 106 to execute various types of processing. Also, the RAM 108 is used as a work area to store data temporarily used by the CPU 106 to execute various types of processing.

The application program stored in the ROM 107 or the RAM 108 contains a control program describing the below-mentioned control processing.

The product read device 100 is usually delivered under the condition where the control program is stored in the ROM 107.

By providing the product read device 100 with an auxiliary storage unit, the product read device 100 may be delivered under the condition where the auxiliary storage unit stores the control program.

As the auxiliary storage unit, an EEPROM (electric erasable programmable read-only memory), hard disk drive, SSD (solid state drive), or the like may be used.

However, the product read device 100 including an auxiliary storage unit may be delivered under the condition where the control program is not stored in the ROM 107 or the auxiliary storage unit.

It is possible to store the control program in a removable storage medium or deliver the control program via the network so that the control program is written to the aforementioned separately delivered auxiliary storage unit of the product read device 100.

A magnetic disk, a magnetic optical disk, an optical disk, a semiconductor memory, or the like can be used as a storage medium.

The keyboard interface 109 acts as an interface for data exchange between the keyboard 102 and the CPU 106.

A well-known device compliant with, e.g., the PS/2 or USB (universal serial bus) specifications can be used as the keyboard interface 109.

The panel interface 110 acts as an interface for exchange of data and a video signal between the touch panel 103 and the CPU 106.

The panel interface 110 includes an interface for a display device and an interface for a touch sensor.

A well-known device compliant with, e.g., the VGA (video graphics array) specifications (analog RGB specifications), the DVI (digital video interface) specifications, or the LVDS (low voltage differential signaling) specifications may be used as an interface for a display device.

A well-known device compliant with, e.g., the USB or RS (recommended standard)-232C specifications can be used as an interface for a touch sensor.

The display interface 111 acts as an interface for video signal exchange between the customer display 104 and the CPU 106.

When the customer display 104 is a fluorescent display device, a well-known device compliant with, e.g., the USB or RS-232C specifications can be used as the display interface 111.

When the customer display 104 is an LCD, a well-known device compliant with, e.g., the VGA, DVI, or LVDS specifications can be used as the display interface 111.

The shooting interface 112 acts as an interface for data exchange between the shooting device 105a and the CPU 106.

A well-known device compliant with, e.g., the USB or IEEE (institute of electrical and electronic engineers) 1394 specifications can be used as the shooting interface 112.

The POS terminal interface 113 acts as an interface for data exchange between the POS terminal 200 and the CPU 106.

A well-known device compliant with, e.g., the USB or RS-232C specifications can be used as the POS terminal interface 113.

As electronic elements, the POS terminal 200 includes, not only the keyboard 202, the operator display 203, the customer display 204, and the printer 205, but also a processor 206, a ROM 207, a RAM 208, an auxiliary storage unit 209, a keyboard interface 210, a display interface (display I/F) 211,212, a printer interface (printer I/F) 213, a read device interface (read device I/F) 214, a drawer interface (drawer I/F) 215, a communication device 216, and a bus line 217.

The bus line 217 includes an address bus and data bus. The bus line 217 connects between the processor 206, the ROM 207, the RAM 208, the auxiliary storage unit 209, the keyboard interface 210, the display interface 211, the display interface 212, the printer interface 213, the read device interface 214, the drawer interface 215, and the communication device 216.

The keyboard 202 includes a plurality of key switches and outputs a command that represent the contents of an operation by an operator using these key switches.

The operator display 203 displays an arbitrary image under control of the processor 206. The operator display 203 is used to display various types of images to be presented to the operator. As the operator display 203, an LCD or the like can be used.

The customer display 204 displays an arbitrary string or image under control of the processor 206.

The customer display 204 is used to display various types of strings or images to be presented to the customer.

As the customer display 204, e.g. a fluorescent display device or LCD can be used.

Under control of the processor 206, the printer 205 prints, on a receipt paper, a receipt image illustrating the transaction content. As the printer 205, various well-known types of existing printers can be used. The printer 205 is typically a thermal printer.

The processor 206 is, e.g., a CPU. The processor 206 is hereinafter simply referred to as the CPU 206. Based on an operating system, middleware, and application program stored in the ROM 207 and the RAM 208, the CPU 206 controls all elements of the POS terminal 200 to perform various types of operations.

The ROM 207 stores the aforementioned operating system. The ROM 207 eventually stores the aforementioned middleware and application program. Also, the ROM 207 eventually stores data to be referenced by the CPU 206 to execute various types of processing.

The RAM 208 stores data to be referenced by the CPU 206 to execute various types of processing. Also, the RAM 208 is used as a work area to store data temporarily used by the CPU 206 to execute various types of processing.

A part of the storage region of the RAM 208 is used as a product list area for managing information on a product whose sale has been registered.

The auxiliary storage unit 209 is, e.g., a hard disk drive or SSD and stores data used by the CPU 206 to execute various types of processing and data generated by processing of the CPU 206.

The keyboard interface 210 acts as an interface for data exchange between the keyboard 202 and the CPU 206. A well-known device compliant with, e.g., the PS/2 or USB specifications can be used as the keyboard interface 210.

The display interface 211 acts as an interface for video signal exchange between the operator display 203 and the CPU 106. A well-known device compliant with, e.g., the VGA, DVI, or LVDS specifications can be used as the display interface 211.

The display interface 212 acts as an interface for video signal exchange between the customer display 204 and the CPU 206. When the customer display 204 is a fluorescent display device, a well-known device compliant with, e.g., the USB or RS-232C specifications can be used as the display interface 212. When the customer display 204 is an LCD, a well-known device compliant with, e.g., the VGA, DVI, or LVDS specifications can be used as the display interface 212.

The printer interface 213 acts as an interface for data exchange between the printer 205 and the CPU 206. A well-known device compliant with, e.g., the USB or RS-232C specifications or the IEEE1284 specifications (also referred to as the Centronics specifications) may be used as the printer interface 213.

The read device interface 214 acts an interface for data exchange between the product read device 100 and the CPU 206. A well-known device compliant with, e.g., the specifications with which the POS terminal interface 113 are compliant can be used as the read device interface 214.

In response to an instruction by the CPU 206 to open the drawer, the drawer interface 215 outputs, to the drawer 500, a drive signal to open the drawer 500.

The communication device 216 communicates with a server 700 via a communication network 600. As the communication device 216, e.g., an existing LAN communication device can be used.

Operation of the product read device 100 in the shop cashier system configured as described above is hereinafter illustrated.

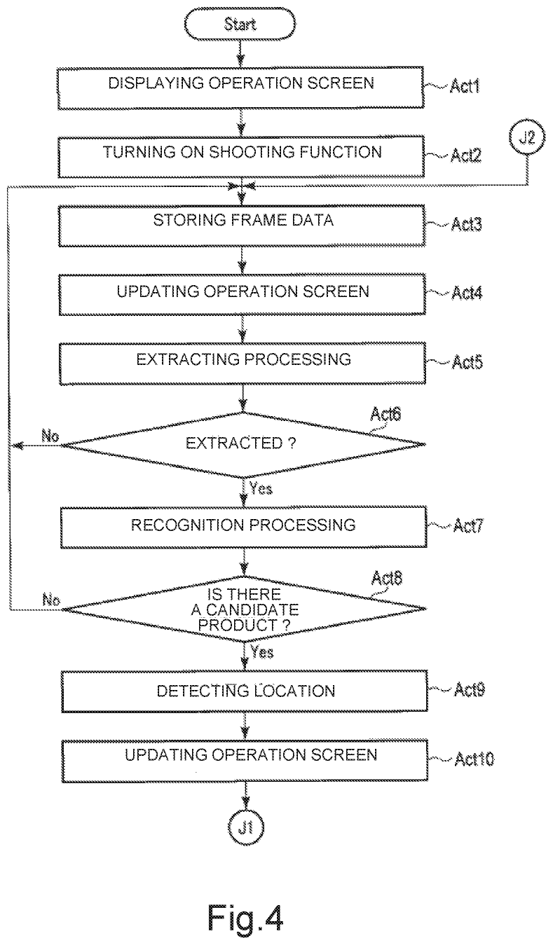

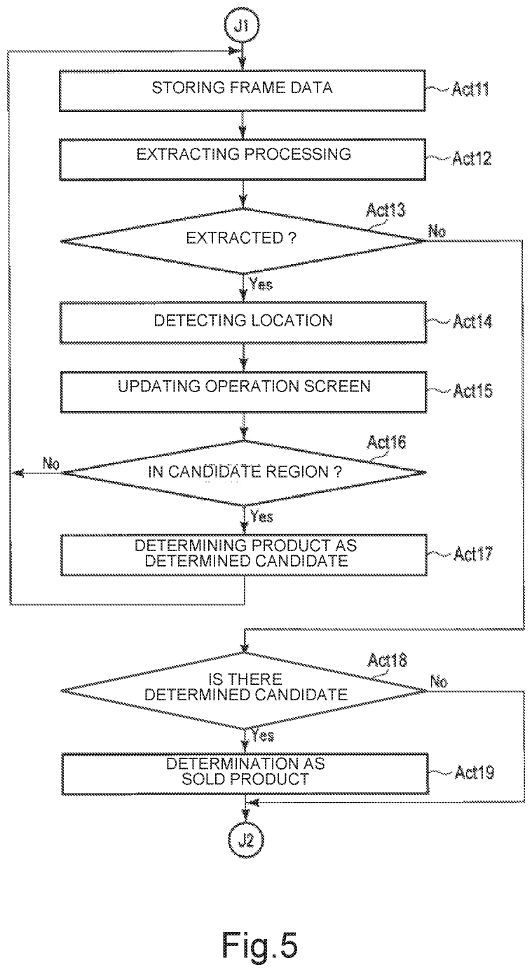

FIGS. 4 and 5 are flowcharts illustrating processing performed by the CPU 106 to control an operation of the product read device 100. The contents of the processing illustrated hereinafter are only examples. The embodiment can be appropriately used in various types of processing that can produce the same results as the results of the examples.

The condition to start the registration procedure for a sold product is satisfied, e.g., when an operator uses the keyboard 202 to perform a predetermined operation to instruct start of registration of the sold product. Upon satisfaction of the condition, the CPU 206 transmits a read start command from the read device interface 214 to the product read device 100.

The CPU 106 is notified of the read start command by the POS terminal interface 113.

Upon receipt of the read start command, the CPU 106 starts the control processing of the FIGS. 4 and 5 according to the control program.

Alternatively, when the operator uses the keyboard 102 or the touch panel 103 to perform a predetermined operation to instruct start of registration of a sold product and the condition to start the registration procedure is satisfied, the CPU 106 starts the control processing of the FIGS. 4 and 5.

In Act 1 illustrated in FIG. 4, the CPU 106 sets the screen of the touch panel 103 as an operation SCREEN. Specifically, the CPU 106, for example, generates operation screen data, which indicates the operation screen, stores the operation screen data in the RAM 108, and control the touch panel 103 so that the touch panel 103 performs display according to the operation screen data. Under this control, the touch panel 103 displays an image from the RAM 108 based on the operation screen data.

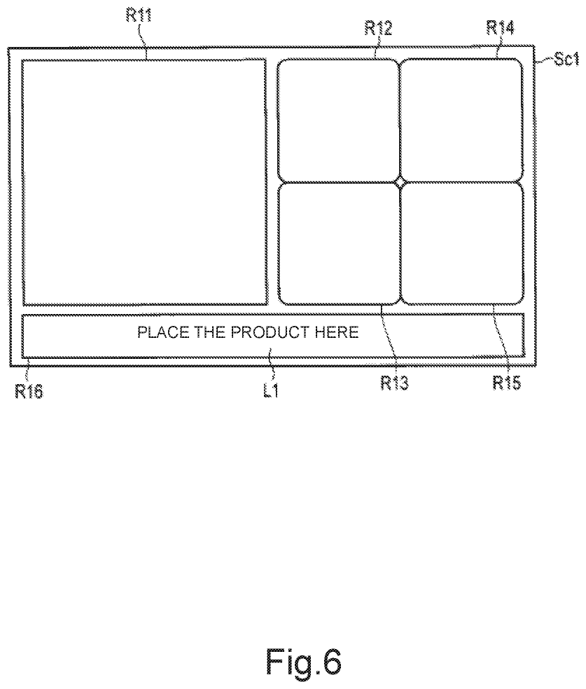

FIG. 6 is a diagram illustrating one example of an operation screen SC1.

The operation screen SC1 contains six regions: regions R11, R12, R13, R14, R15, and R16.

The region R11 is an image display region for displaying a frame image shot by the shooting device 105a. The regions R12 to R15 are regions that display the candidate product name of each of the first to fourth candidates and is used as a button for selecting a candidate product from among the candidate products and determining the selected product as a sold product. The region R16 is a region that displays a message for guiding an operation of the product read device 100.

The regions R11 to R15 on the operation screen SC1 are all blank. The region R16 on the operation screen SC1 displays a text message L1, which prompts the operator to place a sold product placed in front of the shooting device 105. The region R16 displays a message, such as “Place the product here,” as the text message L1.

In Act 2, the CPU 106 starts shooting using the shooting device 105a. Specifically, the CPU 106 outputs a shooting-on signal to the shooting device 105a via the shooting interface 112. Upon receipt of this shooting-on signal, the shooting device 105a starts shooting a moving image. Under this condition, the operator places, over the read window 101a, the sold product that is being held in the hand of the operator, and the sold product appears in the moving image shot by the shooting device 105a. The shooting device 105a periodically outputs frame data.

In Act 3, the CPU 106 stores, in the RAM 108, frame data output from the shooting device 105a.

In Act 4, the CPU 106 updates the operation screen. Specifically, the CPU 106 displays, in the region R11, a mirror image of the frame image represented by frame data stored in the RAM 108.

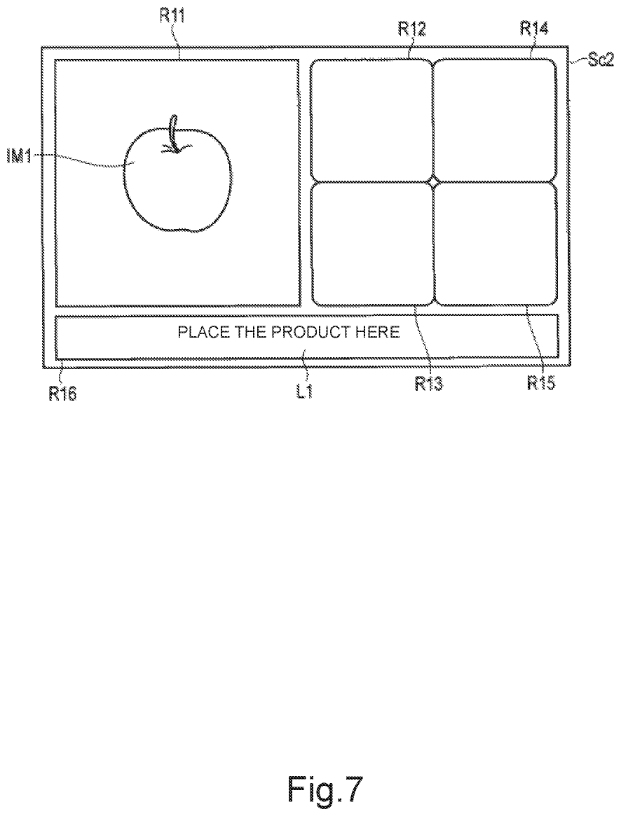

FIG. 7 is a diagram illustrating an operation screen SC2, which is one example operation screen that has been updated from the operation screen SC1 in Act 4.

An element of the operation screen SC2 that is identical to the corresponding element of the operation screen SC1 is assigned the same reference numeral as the reference numeral of the corresponding element of FIG. 6.

The region R11 of the operation screen SC2 displays a frame image containing an image IM1 of the sold product.

In Act 5, the CPU 106 performs extraction processing. The extraction processing is processing to extract an object appearing in a frame image represented by frame data.

Specifically, the CPU 106, for example, first attempts to detect a flesh color region in the frame image. When the flesh color region is detected, in other words, when the operator's hand appears in the frame image, the CPU 106 binarizes the frame image and extracts a counter or the like from the binarized image.

The CPU 106 thereby determines the contour of a sold product assumedly held in the operator's hand.

The CPU 106 extracts the region in the inside of the contour as an object. The operator's hand is not illustrated in FIG. 7.

In Act 6, the CPU 106 confirms whether an object has been extracted. When an object is not extracted, the determination of the CPU 106 is “No,” and the processing of the CPU 106 returns to Act 3. Until an object is extracted, the CPU 106 repeatedly attempts to extract an object, which is to be found in a new frame image. Upon extraction of an object, the determination of the CPU 106 is “Yes” in Act 6, and the processing of CPU 106 proceeds to Act 7.

In Act 7, the CPU 106 performs recognition processing. The recognition processing is processing for identifying to which product's image the object extracted in Act 5 corresponds. A well-known technique can be used for this recognition processing. One specific example of recognition processing is hereinafter illustrated.

The CPU 106 analyzes the object extracted in Act 5 and reads characteristic values, such as shape, surface color, design, and unevenness.

Based on results of matching between the read characteristic values and characteristic values associated with each product in advance, CPU 106 recognizes to which product the extracted object corresponds.

To perform this recognition, one of the ROM 107, the ROM 207, and the auxiliary storage unit 209 stores a recognition dictionary file.

The recognition dictionary file describes a plurality of types of characteristic value data of each product to be recognized, which are associated with the product ID and name in order to identify the product. The product ID uses, e.g., a PLU code (price look up code).

The aforementioned types of characteristic value data are parameterized data representing characteristic values (e.g., exterior surface, color, design, and unevenness) of surface information on a product extracted from a reference image produced by shooting the product in advance—in other words, characteristic values of the exterior appearance.

The recognition dictionary file associates, with the ID of a single product, characteristic value data acquired from each of reference images produced by shooting the product from various directions.

The number of types of characteristic value data per product is not fixed and may be different depending on the product. The name of a product does not need to be contained in the recognition dictionary file.

The aforementioned product recognition is referred to as generic object recognition. This generic object recognition technique is illustrated in the below-referenced literature as a recognition technique and can be used in the aforementioned object recognition processing:

Keiji Yanai, “Present and Future of Generic Object Recognition”, Journal of Information Processing, Vol. 48, No. SIG16 [searched on Aug. 10, 2010], Internet <URL: http://mm.cs.uec.ac.jp/IPSJ-TCVIM-Yanai.pdf>.”

A generic object recognition technique performed by means of dividing an image into regions, each of which corresponds to one object, is illustrated in the below-identified literature. This technique can also be used in the aforementioned object recognition processing:

Jamie Shotton, et. al, “Semantic Texton Forests for Image Categorization and Segmentation”, [searched on Aug. 10, 2010], Internet <URL: http://citeseerx.ist.psu.edu/viewdoc/download?doi=10.1.1.14 5.3036&rep=rep1&type=pdf>.

In general, there exist many products whose exterior appearances are similar. It is not preferable to determine a sold product only by the aforementioned recognition processing.

In Act 7, the CPU 106 selects a certain number of products with the highest levels of similarity to each product, e.g., four most similar products, and sets these products as the first to fourth candidate products in order of ascending similarity.

The CPU 106 writes the PLU code of each of the first to fourth candidates to the RAM 108. However, when the value of the largest similarity level is smaller than a predetermined value, the CPU 106 determines that there is no candidate product.

The CPU 106 executes the control processing according to the control program, and a computer in which the CPU 106 is a core component acts as a recognition unit.

In Act 8, the CPU 106 confirms existence of a candidate product in the aforementioned recognition processing. When there is no candidate product, the determination of the CPU 106 is “No,” and the processing of CPU 106 returns to Act 3. However, when at least the first candidate is set, the determination of the CPU 106 is “Yes,” and the processing of the CPU 106 proceeds to Act 9.

In Act 9, the CPU 106 detects the location of an object. Specifically, the CPU 106 calculates, e.g., the centroid of the range of the object and defines the centroid location as the location of the object. The CPU 106 executes control process according to the control program, and a computer in which the CPU 106 is a core component acts as a detection unit.

In Act 10, the CPU 106 updates the operation screen. Specifically, the CPU 106 controls the touch panel 103 so that the recognition result of Act 7 is displayed on the operation screen. In other words, the CPU 106 controls the touch panel 103 so that in the image displayed in the region R11, a location image illustrating the location detected in Act 9 is displayed so as to overlap the frame image shot by the shooting device 105. The aforementioned location image is, e.g., a marker.

Also, the CPU 106 replaces the display on the region R16 by a text message that prompts the operator to select, from among the candidate products, a product to be determined as a sold product.

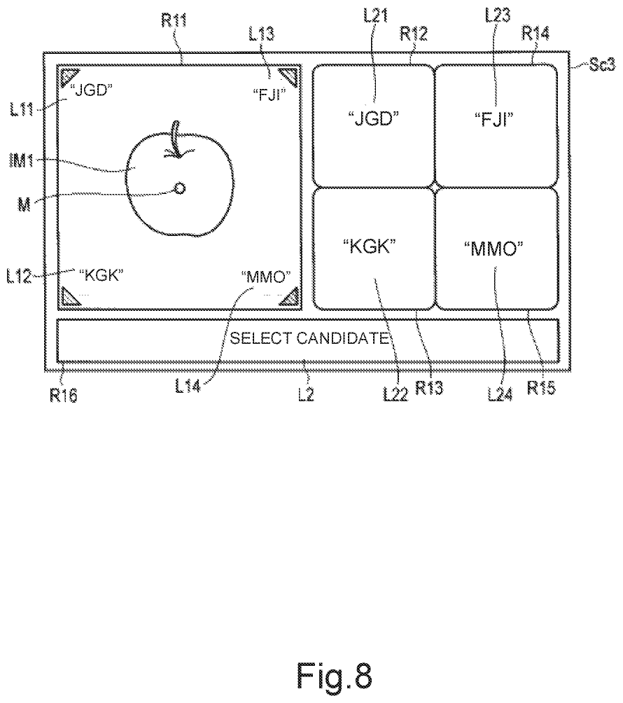

FIG. 8 is a diagram illustrating the operation screen SC3, which is one example screen that has been updated from the operation screen SC2 in Act 10. An element of the operation screen SC3 that is identical to the corresponding element of the operation screen SC1, SC2 is assigned the same reference numeral as the reference numeral of the corresponding element of FIGS. 6 and 7.

In Act 7, the operation screen SC3 displays the situation where, e.g., candidate products whose names are “JGD,” “KGK,” “FJI,” and “MMO,” are set as the first to fourth candidates, respectively.

There are subregions of the region R11 corresponding to the first candidate region 11 to the fourth candidate region 14 of FIG. 3. These subregions display strings L11, L12, L13, L14, which denote the product names of the first candidate region 11 to the fourth candidate region 14, respectively.

The frame image displayed in the region R11 is a mirror image of the frame image represented by the frame data. The subregions of the region R11 corresponding to the first candidate region 11 to the fourth candidate region 14 are in a mirror image relationship, respectively, with the first candidate region 11 to the fourth candidate region 14 of FIG. 3.

The regions R12 to R15 display strings L21, L22, L23, L24 denoting the products name of the first to fourth candidates, respectively.

In the region R11, a marker M, which indicates the location detected in Act 9, is displayed. The region R16 displays a text message L2, which prompts the operator to select, from among the candidate products, a product to be determined as a sold product. The region R16 displays a message, such as “Select candidate,” as the text message L2. The CPU 106 executes the control processing according to the control program, and a computer in which the CPU 106 is a core component acts as a control unit.

After the CPU 106 completes the step of Act 10, the processing of the CPU 106 proceeds to Act 11 illustrated in FIG. 5.

In Act 11, the CPU 106 stores frame data output by the shooting device 105a in the RAM 108.

In Act 12, the CPU 106 performs the same extraction processing as the processing of Act 5.

In Act 13, the CPU 106 confirms whether an object has been extracted. When the object has been extracted, the determination of the CPU 106 is “Yes,” and the processing of the CPU 106 proceeds to Act 14.

In Act 14, the CPU 106 detects the location of the object as in the case of Act 9. The location detected in Act 9 and Act 14 is hereinafter referred to as the detected location.

In Act 15, the CPU 106 updates the operation screen. Specifically, the CPU 106 replaces the display in the region R11 by the frame image represented by the frame data newly stored in Act 11.

Also, the CPU 106 changes the display location of the marker M so that the aforementioned newly detected location of Act 14 is displayed in the region R11.

Specifically, the CPU 106 controls the touch panel 103 so that the aforementioned location image illustrating the aforementioned latest detected location of the object is displayed so as to overlap the aforementioned frame image.

Also, the CPU 106 recognizes a change of direction of the location of the aforementioned object by detecting the object location.

Specifically, the CPU 106 calculates the change of direction from the previously detected location to the newly detected location in Act 14.

The CPU 106 controls the touch panel 103 so that the aforementioned location image illustrating the aforementioned latest detected location of the object and the direction image illustrating the change of direction recognized by the aforementioned calculation (hereinafter referred to as the “indicator”) are displayed so as to overlap the aforementioned frame image.

Also, the CPU 106 enlarges the string displayed at a location corresponding to the candidate region that is the forefront region of all the first candidate region 11 to the fourth candidate region 14 in the aforementioned direction. Specifically, the CPU 106 controls the touch panel 103 so that upon detection of the location of the object, as the location of the object nears the aforementioned operational regions (the first candidate region 11 to the fourth candidate region 14), the product name of the aforementioned candidate product is enlarged when displayed.

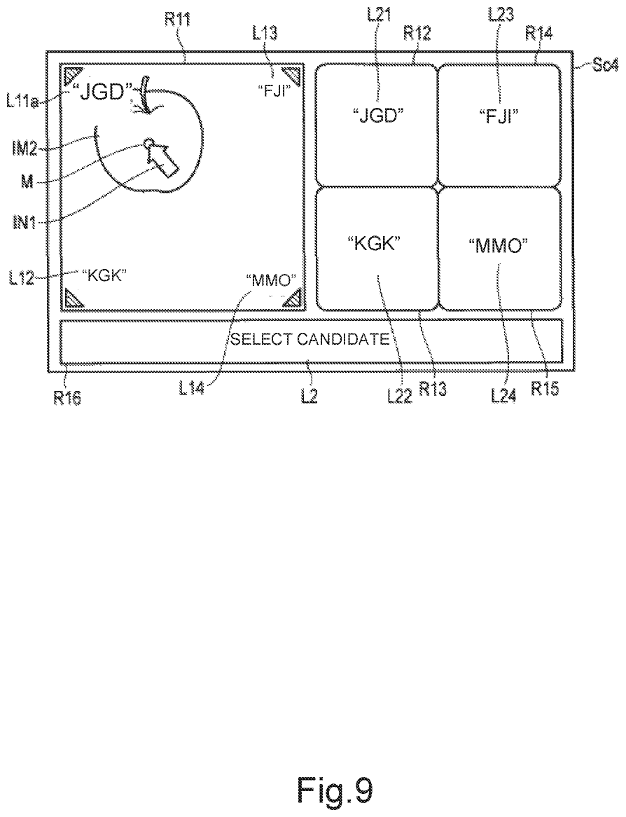

FIG. 9 is a diagram illustrating the operation screen SC4, which is one example operation screen that has been updated from the operation screen SC3 in Act 15.

An element of the operation screen SC4 that is identical to the corresponding element of the operation screen SC1 to SC3 is assigned the same reference numeral as the reference numeral of the corresponding element of FIGS. 6 to 8.

The operation screen SC4 illustrates the situation where the operator moves a sold product placed in front of the shooting device 105 toward the oblique upper left direction.

The region R11 displays a frame image containing an image IM2 of the sold product.

In the region R11, a marker M has been moved to the detected location of the object, which is to be found in the image IM2.

The region R11 displays an indicator IN1, which illustrates the change of direction of the location of the marker M. The string L11 in the operation screen SC3 has been replaced by the string L11a, which is larger than the string L11.

Even when the operator does not intend to move a sold product, the product often moves little by little.

When an indicator is used to illustrate the change of direction of the location of the object due to this type of movement of the sold product, indicators pointing different directions are successively displayed in a short period of time, and there is a possibility that the operation screen is difficult to see.

Therefore, it is preferable to take some measure to prevent the foregoing situation from occurring.

One conceivable measure is, e.g., to lower the resolution at which location detection is conducted in Act 9 and Act 14.

Another conceivable measure is to create a setting where an indicator appears only when the location change exceeds a predetermined amount.

In Act 16, the CPU 106 confirms whether the detected location is in one candidate region (operational region) of the first candidate region 11 to the fourth candidate region 14.

When the detected location is none of the first candidate region 11 to the fourth candidate region 14, the determination of the CPU 106 is “No,” and the processing of the CPU 106 returns to Act 11.

As long as an object can be extracted based on each frame data successively output by the shooting device 105a and the object is located in a region that is none of the first candidate region 11 to the fourth candidate region 14, the CPU 106 repeats the processing of Act 11 to Act 16.

When the detected location is in one candidate region (operational region) of the first candidate region 11 to the fourth candidate region 14, the determination of the CPU 106 is “Yes” in Act 16, and the processing of the CPU 106 proceeds to Act 17.

In Act 17, the CPU 106 provisionally determines, as a sold product, a candidate product associated with one region of the first candidate region 11 to the fourth candidate region 14, where the detected location exists.

Thereafter, the processing of the CPU 106 returns to Act 11.

Specifically, the functional regions (the first candidate region 11 to the fourth candidate region 14) in this case are operational regions associated with an operation for achieving a selection function for selecting a determined candidate from among the candidate products, in other words, an operation for sales registration.

The CPU 106 executes the control processing according to the control program, and a computer in which the CPU 106 is a core component acts as an input unit for inputting the aforementioned operation.

When the operator moves the sold product placed in front of the shooting device 105 to the outside of the field of vision of the shooting device 105, the sold product does not appear in a frame image. The CPU 106 is unable to extract an object in Act 12. In this case, the determination of the CPU 106 is “No” in Act 13, and the processing of the CPU 106 proceeds to Act 18.

In Act 18, the CPU 106 confirms whether a sold product is provisionally determined. When provisionally determined, the determination of the CPU 106 is “Yes,” and the processing of the CPU 106 proceeds to Act 19.

In Act 19, the CPU 106 determines that the provisionally determined product as a sold product. In this case, via the POS terminal interface 113, the CPU 106 notifies the POS terminal 200 of the PLU code of the sold product thus determined. The processing of the CPU 106 returns to Act 3 in FIG. 4.

The aforementioned PLU code notified to POS terminal 200 is received by the read device interface 214.

The read device interface 214 notifies the CPU 206 of the PLU code.

In response, the CPU 206 performs data processing relating to sale of the product that is identified based on the notified PLU code. This data processing may be, e.g., the same as processing performed by another existing POS terminal.

A computer in which the CPU 206 is a core component acts as a processing unit.

When the sold product has not been provisionally determined, the determination of the CPU 106 is “No” in Act 18. The processing of the CPU 106 circumvents Act 19 and returns to Act 3 in FIG. 4.

When an object cannot be extracted before going through one region of the first candidate region 11 to the fourth candidate region 14 associated with a candidate product, the CPU 106 deletes the recognition result in Act 7 and returns to the state of attempting to extract a new object.

While the processing loop of Act 11 to Act 16 is being repeated, the CPU 106 determines, as a sold product, a candidate product corresponding to a touched region upon detection by the touch panel 103 that one of the regions R12 to R15 has been touched.

Thereafter, the CPU 106 repeats the same processing as the processing of Act 11 to Act 13 until there is no object to be extracted. When there is no object to be extracted, the processing of the CPU 106 returns to Act 3.

However, this processing is omitted in FIGS. 4 and 5. Even after occurrence of the situation where no object can be extracted, the CPU 106 may be set so that the processing for determining a sold product in response to touching of one of the regions R12 to R15 continues until a new object is extracted.

When the detected location of the recognized object is in one region of the first candidate region 11 to the fourth candidate region 14, which is an operation region associated with a selection operation for a candidate product, the CPU 106 determines, as a determined candidate, a candidate product for which the selection operation associated with the candidate region is performed.

When an object cannot be extracted in a situation where the determined candidate has been set, the CPU 106 determines the determined candidate product as a sold product.

When the screen of the touch panel 103 is the operation screen SC3 of FIG. 8, the operator can move the sold product to the outside of the field of view of the shooting device 105 by passing the sold product through the candidate region (operational region) where the product name of the candidate product is displayed. Thereby, the operator can determine, as a sold product, the product for whose name the selection operation associated with the passed region is performed.

In this situation, the operator should move the marker M displayed in the region R11 toward the candidate region (operational region), where the name of the product to be determined is displayed.

Accordingly, the operator can appropriately move a sold product in order to determine the sold product as a proper product.

Also, by visually checking, e.g., the indicator IN1 illustrated in FIG. 9, the operator can find how the product read device 100 recognizes the movement of the sold product.

The operator can thereby properly move a sold product in order to determine the sold product as a proper product.

Also, the operator can find that the sold product is moving in a wrong direction when the product name indicated by an enlarged string, such as the string Lila illustrated in FIG. 9, is different from the name of the product to be determined as a sold product.

By moving a product to be determined as a sold product so that the name of the product is enlarged, the operator can more properly move the sold product in order to determine the sold product as a proper product.

This embodiment can be modified in various ways as follows:

The region R11 may display the path of the location of an object instead of the indicator.

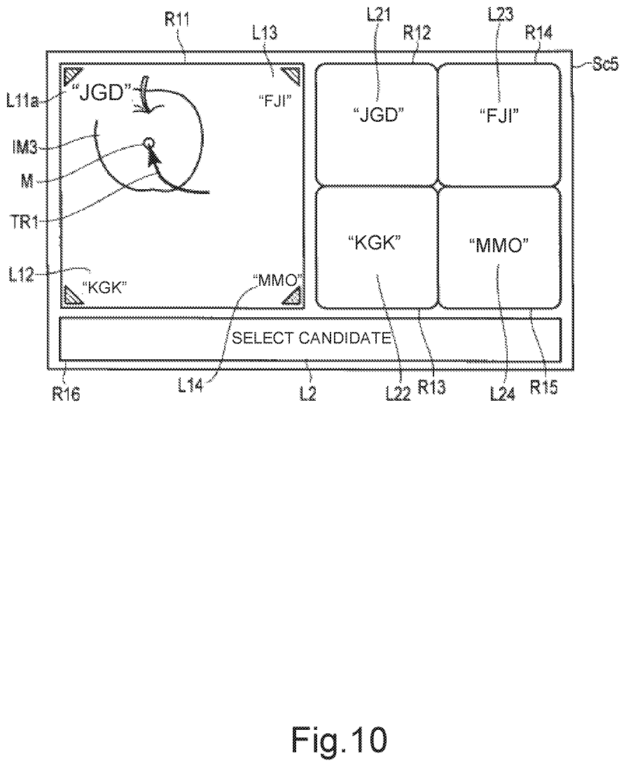

FIG. 10 is a diagram illustrating an operation screen SC5, which is a modification of the operation screen SC4. An element of the operation screen SC5 that is identical to the corresponding element of the operation screens SC1 to SC4 is assigned the same reference numeral as the reference numeral of the corresponding element of FIGS. 6 to 9.

The region R11 displays a frame image containing an image IM3 of a sold product. The marker M is displayed at the detected location of the object, which is to be found in the image IM3, in the region R11.

The region R11 also displays a path image TR1, which illustrates the path of the location of the object.

The CPU 106 recognizes a path depicting a change of the location of the object by detecting the location of the object.

The CPU 106 can display the path image TR1 by, e.g., simultaneously displaying, in the region R11, the location repeatedly detected in Act 14.

Also, the CPU 106 can display the path image TR1, e.g., as a curve or lines connecting, in a time sequence, the location repeatedly detected in Act 14.

The CPU 106 controls the touch panel 103 so that the aforementioned location image illustrating the latest detected location of the object and the path image illustrating the path depicting a change of the location of the object are displayed so as to overlap the aforementioned shot image.

A region corresponding to one region of the first candidate region 11 to the fourth candidate region 14 may be associated with an operation other than an operation for selecting a sold product.

Alternatively, a region other than the first candidate region 11 to the fourth candidate region 14 may be set as a region associated with an operation other than an operation for selecting a sold product.

A region corresponding to one region of the first candidate region 11 to the fourth candidate region 14 or another region may be associated with an operation other than a sales registration operation.

This embodiment can be embodied as an apparatus that recognizes a product for a purpose other than product sales registration.

According to this embodiment, the product read device 100 may, instead of being equipped with the shooting device 105, incorporate frame data acquired by an external shooting device to perform the aforementioned processing.

The specific content of the processing of the CPU 106 may be optionally changed as long as the same function as the function of the CPU 106 can be achieved.

For example, in the above embodiment, the product read device 100 has all functions for the steps prior to the step of determining the product. However, the functions may be distributed to the product read device 100 and the POS terminal 200.

The POS terminal 200 may have all functions for the steps prior to the step of determining the product.

The control processing of FIGS. 4 and 5 may be, in whole or in part, achieved by processing of the CPU 206 based on the control program stored in the ROM 207 or the auxiliary storage unit 209.

This embodiment may be embodied as a cashier counter or a POS terminal in which the function of the product read device 100 is embedded.

The technique according to this embodiment can be used not only in product recognition for sales data processing, but also in various types of product recognition.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A product recognition apparatus comprising:
a shooting device configured to shoot a moving image of a moving object and output frame data representing a frame image constituting the moving image;
a display configured to display an operation screen and display the frame image in an image display region contained in the operation screen;
a memory configured to store operation screen data for displaying the operation screen and the frame data; and
a processor configured to:
recognize an object contained in the frame image based on the frame data stored in the memory;
determine a specific location of the recognized object in the frame image, the specific location being a location of a specific part within an area of the recognized object in the frame image;
control the display so that based on the operation screen data and the frame data stored in the memory, a location image representing a location of the recognized object is displayed at the determined specific location so as to overlap the frame image in the image display region of the operation screen, the location image moving with the movement of the recognized object; and
accept an input of a predetermined operation in response to detection of the specific location of the recognized object in an operational region that is defined in advance in a range of the frame image and associated with the predetermined operation.

2. The product recognition apparatus according to claim 1, wherein
the processor controls the display so that the location image representing a latest detected location of the recognized object is displayed at the determined specific location so as to overlap the frame image.

3. The product recognition apparatus according to claim 1, wherein
the processor is configured to repetitively determine the specific location of the recognized object and thereby determine a moving direction of the specific location of the recognized object, and
the processor controls the display so that the location image and a direction image indicating the moving direction of the specific location of the recognized object is displayed so as to overlap the frame image.

4. The product recognition apparatus according to claim 1, wherein
the processor is configured to repetitively determine the specific location of the recognized object and thereby determine a moving path of the specific location of the recognized object; and
the processor controls the display so that the location image and a path image indicating the moving path of the recognized object are displayed so as to overlap the frame image.

5. The product recognition apparatus according to claim 1, wherein
the location image comprises a mark.

6. The product recognition apparatus according to claim 1, wherein
the location image overlaps the object in the frame image.

7. A product recognition apparatus comprising:
a shooting device configured to shoot a moving image of a moving object and output frame data representing a frame image constituting the moving image;
a display configured to display an operation screen containing an image display region for displaying the frame image and a button display region for displaying a button which accepts an input of a predetermined operation and simultaneously display the frame image and the button;
a memory configured to store operation screen data for displaying the operation screen and the frame data; and
a processor configured to:
recognize an object contained in the frame image based on the frame data stored in the memory;
determine a specific location of the recognized object in the frame image, the specific location being a location of a specific part within an area of the recognized object in the frame image;
control the display so that based on the operation screen data and the frame data stored in the memory, a location image representing a location of the recognized object is displayed at the determined specific location so as to overlap the frame image in the image display region of the operation screen; and
accept an input of the predetermined operation in response to detection of the specific location of the recognized object in an operational region that is defined in advance in a range of the frame image and associated with the predetermined operation.

8. The product recognition apparatus according to claim 7, wherein
the displayed position of the button in the button display area corresponds to the position of the defined operation area in the area of the frame image.

9. The product recognition apparatus according to claim 7, wherein
the processor controls the display so that the location image representing a latest detected location of the recognized object is displayed at the determined specific location so as to overlap the frame image.

10. The product recognition apparatus according to claim 7, wherein
the processor is configured to repetitively determine the specific location of the recognized object and thereby determine a moving direction of the specific location of the recognized object, and
the processor controls the display so that the location image and a direction image indicating the moving direction of the specific location of the recognized object is displayed so as to overlap the frame image.

11. The product recognition apparatus according to claim 7, wherein
the processor is configured to repetitively determine the specific location of the recognized object and thereby determine a moving path of the specific location of the recognized object; and
the processor controls the display so that the location image and a path image indicating the moving path of the recognized object are displayed so as to overlap the frame image.

12. The product recognition apparatus according to claim 7, wherein
the location image comprises a mark.

13. The product recognition apparatus according to claim 7, wherein
the location image overlaps the object in the frame image.
